(19) United States
(12) Patent Application Publication
(10) Pub. No.: US 2020/0203963 A1
(43) Pub. Date: Jun. 25, 2020

(54) CELL BALANCER

(71) Applicant: The Aerospace Corporation, EI Segundo, CA (US)

(72) Inventors: Eric Joseph NEMANICK, Santa Monica, CA (US); Margot WASZ, El Segundo, CA (US)

(73) Assignee: The Aerospace Corporation, El Segundo, CA (US)

(21) Appl. No.: 16/227,122

(22) Filed: Dec. 20, 2018

(51) Int. Cl. H02J 7/00; G06K 19/07; G06K 19/077

(52) U.S. Cl. CPC H02J 7/0021; G06K 19/07773; G06K 19/0723; H02J 7/0014

(57) ABSTRACT

A cell balancer includes a low power radio frequency identification (RFID) tag and a battery monitoring unit (BMU). The RFID tag is configured to measure voltage of a cell in a battery and the BMU is configured to perform voltage management of the cell. The BMU is configured to instruct the RFIG tag to measure voltage of the cell in the battery and receive from the RFID tag the measured voltage of the cell.

### FIELD

The present invention relates to balancing voltages of cells within a battery, and, more particularly, to a cell balancer configured to monitor the voltage of cells within a battery.

### BACKGROUND

A battery typically has one or more strings of cells. During charge and discharge, not all cells charge or discharge to the same voltage. There are several reasons for this. For example, one of the cells may be soft shorted, may have a different capacity, or may have a higher impedance than other cells in the string. This means that there may be a cell in the string that has a lower voltage then the other cells. As a result, each time the cells are charged, there will always be a cell with a lower voltage than the remaining cells in the string. With each cycle, the voltage difference between the lower voltage cell and the remaining cells in the string increases, leading to a divergence in the voltage of the cells in a string. As one cell drops lower in voltage relative to the other cells in the string, the voltage of the other cells is driven higher, and the final voltage of the entire string is fixed at the end of charge. The low voltage cell can end up being discharged below the minimum voltage at the end of discharge, and the other cells can be driven above the maximum voltage at the end of charge. Both of these conditions can cause a reduction in the capacity or cycle life of the cells, or even lead to dangerous shorts and even catastrophic fires.

Thus, cell balancing is required for long life, high reliability battery operation.

Current solutions, such as active balancing, passive balancing, and no balancing at all, are weighty, complicated, and/or create multiple new points for failure. For example, the passive cell balancing solution involves applying a constant power drain on all of the cells during operation, discharging the higher voltage cells slightly faster than lower voltage cells, minimizing the divergence of the voltages of the cells in the string. This option operates independent of any actual failures, and constantly wastes energy.

Active balancing uses the Battery Management Unit (BMU) to monitor the voltage of each cell in a string and requires an additional mechanism to bypass each cell to limit overcharging of high voltage cells and finish charging low voltage cells. However, this solution requires additional wiring and harnesses, as well as a cell bypass mechanism for each cell, increasing battery weight and introducing significant failure mechanisms.

The no cell balancing solution requires extremely tight manufacturing controls and additional testing and screening of the cells prior to battery assembly. In this solution, the manufacturer essentially guarantees that all cells in the battery are 100 percent identical in performance and will remain so over all of the battery life. However, this solution does not account for any changes in cell condition over life, as well as requiring that the expected ageing of all of the cells will be identical.

Thus, an alternative solution may be beneficial.

### SUMMARY

Certain embodiments of the present invention may provide solutions to the problems and needs in the art that have not yet been fully identified, appreciated, or solved by current cell balancing technologies.

In an embodiment, a cell balancer include a low power radio frequency identification (RFID) tag attached to a cell. The low power RFID tag includes a voltage measurement circuit configured to measure the voltage of the cell. The lower power RFID tag also includes a RF antenna configured to communicate the measured voltage of the cell with one or more other cells within a string of cells or communicate the measured voltage of the cell with a BMU.

In another embodiment, a system includes a low power radio frequency identification RFID tag and a BMU. The RFID tag is configured to measure voltage of a cell in a battery and the BMU is configured to perform voltage management of the cell. The BMU is configured to instruct the RFIG tag to measure voltage of the cell in the battery and receive from the RFID tag the measured voltage of the cell.

In yet another embodiment, a system configured to balance voltage in a plurality of cells includes a BMU configured to monitor voltages in each of the plurality of cells. Each of the plurality of cells comprises a low power RFID tag configured to communicate data with the BMU. The low power RFID tag includes a RF antenna configured to communicate with the BMU, and a voltage measurement circuit configured to measure voltage of a corresponding one of the plurality of cells.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a process for balancing a string of cells in a battery, according to an embodiment of the present invention.

FIG. 2 is a block diagram illustrating a RF cell balancer, according to an embodiment of the present invention.

FIG. 3 is a block diagram illustrating a RFID tag with a RF antenna and a voltage measurement circuit, according to an embodiment of the present invention.

FIG. 4 is a block diagram illustrating a RFID tag with an internal clock, according to an embodiment of the present invention.

FIG. 5 is a block diagram illustrating a RF cell balancer with a RFID reader, according to an embodiment of the present invention.

### DETAILED DESCRIPTION OF THE EMBODIMENTS

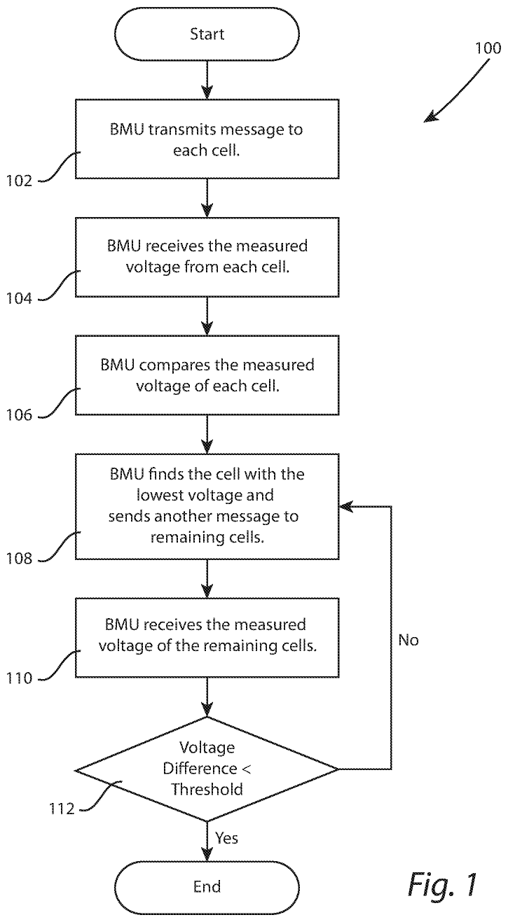

FIG. 1 is a flow diagram illustrating a process 100 for balancing a string of cells in a battery, according to an embodiment of the present invention. In this embodiment, process 100 begins at 102 with a BMU transmitting a signal (or message) to each cell in the string of cells. The message includes a request for measuring voltage of the cell. At 104, the BMU receives the measured voltage from each cell, and at 106, compares the measured voltage of each cell in the string. In some embodiments, BMU may record the measured voltage of each cell in a list, which is stored in a database. The database may be part of, or separate from, the BMU. If the maximum difference in voltage between all of the cells is below a balancing threshold value (the “threshold”), the process ends. If the maximum difference in voltage is above the threshold the process proceeds to step 108.

At 108, the BMU compares the recorded voltage of all of the cells to find the cell with the lowest voltage (the “lowest voltage cell”). This lowest voltage cell is excluded from further measurement. The BMU then submits another message to the remaining cells in the string for voltage measurement. At 110, the BMU receives the measured voltage from the remaining cells, and at 112, determines if the difference in voltage of the messaged cells is greater than the threshold. If the voltage difference is greater than the threshold, the process returns to 108. If the maximum voltage difference is less than the threshold, the process ends.

This embodiment assumes that all cells have the same voltage except for one (lowest voltage) cell, and each time a request is sent to the remaining cells, the act of measuring and reporting the voltage of the cells to the BMU places a load on to the remaining cells, which drains a small amount of energy from the remaining cells, lowering their voltages. This cycle continues until all cells in the string of cells have the same measured voltage; thus, cell balancing.

FIG. 1 may also account for the embodiment where each cell has a different voltage. For example, in a string of 10 cells, each cell may have a different measured voltage. In such an embodiment, the BMU continues to transmit a voltage measurement request to the higher voltage cells, until the voltage of all cells in the string of cells has been reduced to a voltage that is equal to the lowest voltage cell.

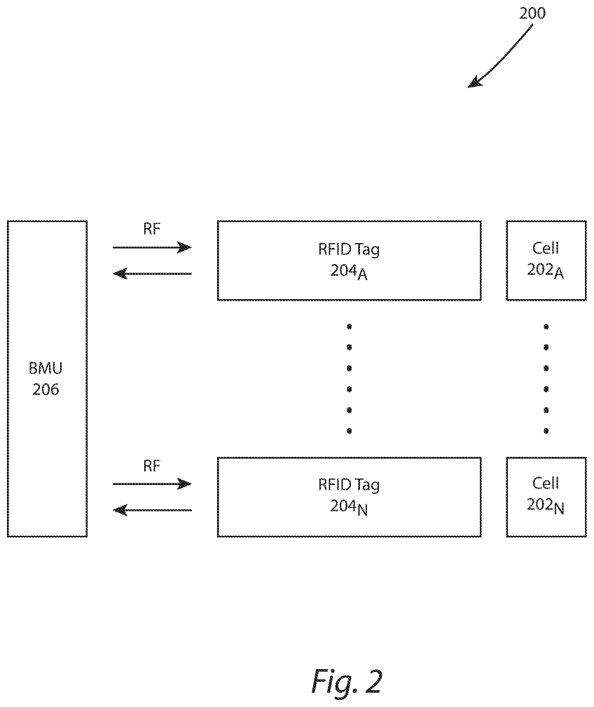

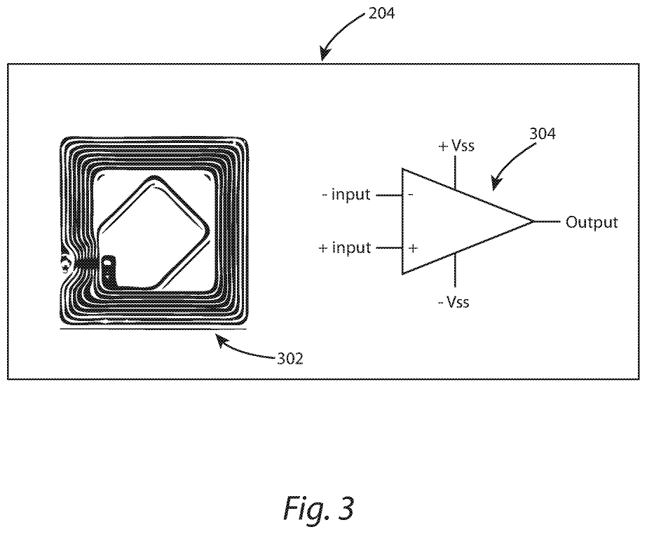

FIG. 2 is a block diagram illustrating a RF cell balancer 200, according to an embodiment of the present invention. In some embodiments, each cell 202_{A} . . . 202_{N} may include a RFID tag 204_{A} . . . 204_{N}, which may be part of the cell packaging, configured to communicate (e.g., send and receive data) with BMU 206 by way of RF communication. See, for example, FIG. 3, which is a block diagram illustrating a RFID tag 204, according to an embodiment of the present invention.

In FIG. 3, RFID tag 204 includes a RF antenna 302 and a voltage measurement circuit 304. In some embodiments, RF antenna 302 may have a metallic pattern that is printed on the cell wrapper and may communicate with the BMU by way of RF communications.

Since RFID tag 204 is part of the cell packaging, very little power is consumed. For example, during operation, unless a message is received from the BMU, RFID tag 204 remains in a ‘sleep state’ to conserve energy. The energy from the signal (or a message) provided by the BMU is configured to initially power RFID tag 204. When RFID tag 204 is in an ‘active state’, RFID tag 204 consumes a small amount of energy from the cell. For example, the measuring of the cell voltage by voltage measurement circuit 304 is configured to power RFID tag 204. This measured voltage may then be communicated from RF antenna 302 to the BMU.

Returning to FIG. 2, BMU 206 may transmit a signal to each RFID tag 204_{A} . . . 204_{N}. In response, RFID tag 204_{A} . . . 204_{N} may measure the voltage of each corresponding cell 202_{A} . . . 202_{N} and transmit the corresponding measurements to BMU 206.

BMU 206, upon receipt of each cell's measured voltage, is configured to compare the measured voltage for each cell 202_{A} . . . 202_{N} to identify the lowest voltage cell in the string of cells. Once the lowest voltage cell is identified, BMU 206 is configured to transmit another signal (or message) to the remaining cells with the higher voltage while the lowest voltage cell is in a ‘sleep mode’. For example, BMU 206 may send a signal to the RFID tag of the lowest voltage cell instructing it to change to a ‘sleep mode’. In another embodiment, the lack of a message from BMU 206 may result in the cell with the lowest voltage moving to ‘sleep mode’. The voltage measurement circuit of the remaining cells may perform another voltage measurement and transmit the measured voltage for each of the remaining cells to BMU 206.

Each time BMU 206 transmits a message, a small load is applied to cells 202_{A} . . . 202_{N} to lower the voltage of cells 202_{A} . . . 202_{N}. This continues until all cells 202_{A} . . . 202_{N} in the string of cells have the same measured voltage.

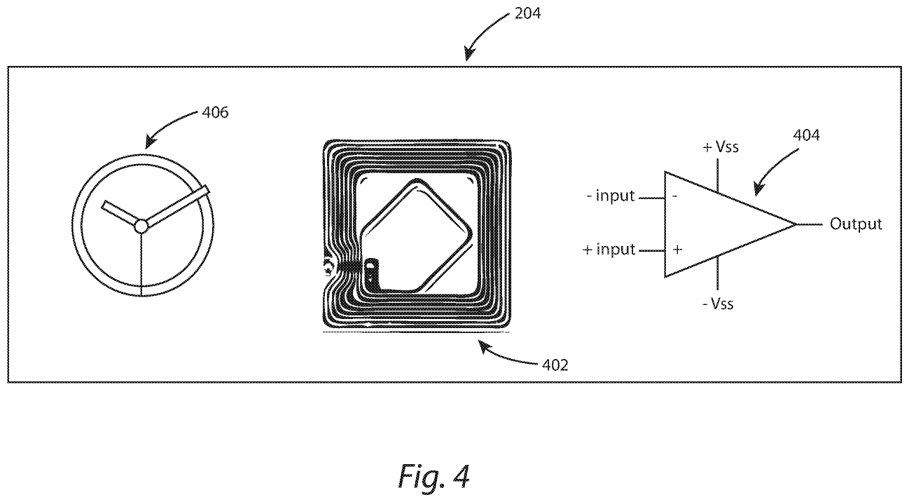

FIG. 4 is a block diagram illustrating a RFID tag 204 with an internal clock 408, according to an embodiment of the present invention. Like FIG. 3, RFID tag (or chip) 204 includes a RF antenna 402 and a voltage measurement circuit 404 with similar functions. This embodiment, however, also includes a clock 406. Clock 406 is configured to activate RFID tag 204. When activated, voltage measurement circuit 404 is configured to measure the voltage of a cell and transmit the measured voltage of the cell to the other cells in the string, rather than the BMU.

This embodiment operates independently of the BMU, and each cell in the string wakes up at a predetermined time or periodically to compare voltages with each other. In this embodiment, after a voltage measurement is made by each cell and that information is transmitted to the other cells in the string, each cell compares its own voltage to the voltages of the other cells in the string. The lowest voltage cell goes into ‘sleep mode’ and is exempt from further measurements until the balancing process ends. The remaining cells continue to measure their own voltages, and compare to the last reported value of the lowest voltage cell. If the cell's voltage is equal to the lowest voltage cell's voltage, that cells goes to sleep. If their voltage is greater than the lowest voltage cell's voltage, the process repeats, until all cells have entered ‘sleep mode’, from all voltage being equal, thus balancing the string.

This embodiment may not require the presence of a sophisticated BMU, as this embodiment enables each cell in a string to be capable of independently balancing their voltage in the string. This would streamline battery manufacture and design, as these cells would be modularly capable of voltage balancing, and would not be required to designed into the battery.

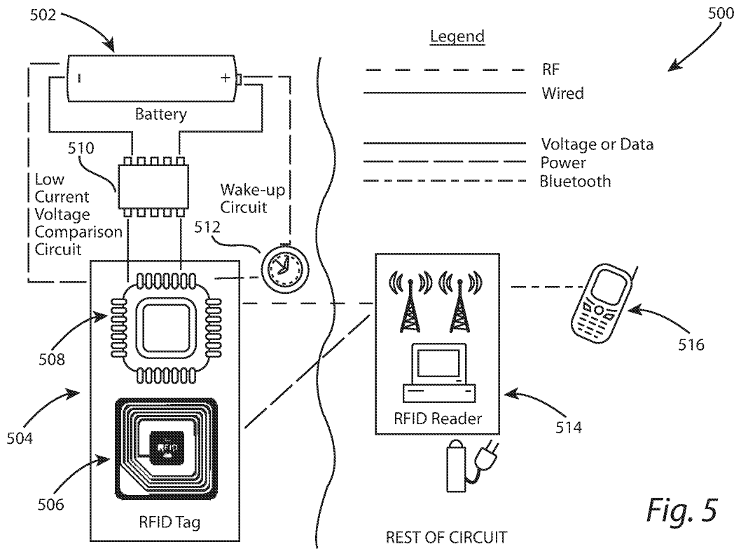

FIG. 5 is a block diagram illustrating a RF cell balancer 500 with a RFID reader 514, according to an embodiment of the present invention. In this embodiment, a cell 502 may be connected to a RFID tag 504. Similar to FIG. 3, RFID tag 504 may include a RF antenna 506. However, in this embodiments, rather than communicating with a BMU, RF antenna 506 may communicate with RFID reader 514. RFID tag 504 may also include a chip 508, which includes memory and logic, along with wake-up circuit 512 and comparator circuit 510). Similar to the other embodiments, wake-up circuit 512 is configured to activate comparator circuit 510, which in turn compares the voltage of cell 502.

This embodiments assumes that each cell in the string of cells may communicate with each other by way of RF antenna 506. By communicating with each other, the voltage decision make is now distributed among the cells, i.e., chip 508 on each cell has more capabilities than in the other embodiments. For example, if there are 8 cells in a string, each cell has a list of its own voltage and the voltages of the other cells. By maintaining a list and communicating its own voltage with other cells, each cell may make its own independent decision to sleep or continue to reduce the voltage from the cell.

During operation, when comparator circuit (or low current voltage comparison circuit) 510 checks the voltage of cell 502, the list, which is saved in memory onboard chip 508, is updated and RF antenna 506 transmits cell's 502 voltage to the other cells. Further, chip 508 may compare cell's 502 voltage among the other cells' voltages and determine whether cell's 502 voltage is the lowest voltage cell. If so, chip 508 may force cell 502 to sleep; otherwise, chip 508 may continue to cause comparator circuit 510 to measure voltage until cell's 502 voltage is equal to the lowest voltage cell.

Also, in certain embodiments, RFID reader 514 may check the status of cell 502. For example, RFID reader 514 may issue a command to RFID tag 504 to measure the voltage of cell 502, and upon receipt of the measurement, may communicate the voltage to mobile device 216. In another example, by communicating with RFID tag 504, RFID reader 514 may receive the list containing all cells' voltages, and in a further example, may communicate the list with mobile device 516.

In some embodiments, a system for maintaining uniform voltage in a string of cells includes a low power RFID tag configured to measure voltage of a cell in a battery. The system also includes a BMU configured to perform voltage management of the cell. The BMU is configured to instruct the RFIG tag to measure voltage of the cell in the battery and receive from the RFID tag the measured voltage of the cell.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A cell balancer, comprising:
a low power radio frequency identification (RFID) tag attached to a cell comprising
a voltage measurement circuit configured to measure the voltage of the cell, and
a RF antenna configured to communicate the measured voltage of the cell with one or more other cells within a string of cells or communicate the measured voltage of the cell with a battery monitoring unit (BMU).

2. The cell balancer of claim 2, wherein the RFID tag comprises a clock configured to periodically activate the RFID tag at a predefined time.

3. The cell balancer of claim 2, wherein the RFID tag comprises a chip configured to record the measured voltage of the cell and record measured voltages received from the other cells.

4. The cell balancer of claim 3, wherein the chip is configured to compare the measured voltage of the cell with the recorded measured voltages received from the other cells to determine if the cell associated with the RFID is a lowest voltage cell.

5. The cell balancer of claim 4, wherein the chip is further configured to switch the RFID to a sleep state when the measured voltage of the cell is lower in voltage compared to the measured voltages received from the other cells in the string of cells.

6. The cell balancer of claim 4, wherein the chip is further configured to instruct the voltage measurement circuit to measure the voltage of the cell until the measured voltage is equal to the lowest voltage cell.

7. The cell balancer of claim 1, wherein the BMU is configured to record the measured voltage of the cell and record the measured voltages received from other cells in a string of cells.

8. The cell balancer of claim 7, wherein the BMU is configured to compare the measured voltage of the cell and the measured voltages received from the other cells to identify a lowest voltage cell, wherein
the lowest voltage cell has a voltage lower than the other cells in the string of cells.

9. The cell balancer of claim 8, wherein the BMU is configured to continuously transmit a signal to the cell and the other cells in the string of cells until the measured voltage of the cell and the measured voltage of the other cells are equal to the voltage of the lowest voltage cell.

10. A system, comprising:
a low power radio frequency identification (RFID) tag configured to measure voltage of a cell in a battery;
a battery monitoring unit (BMU) configured to perform voltage management of the cell, wherein
the BMU is configured to instruct the RFIG tag to measure the voltage of the cell in the battery and further configured to receive from the RFID tag the measured voltage of the cell.

11. The system of claim 10, wherein the RFID tag is attached to the cell.

12. The system of claim 10, wherein the RFID tag comprises a RF antenna configured to receive instructions from, and transmit the measured voltage of the cell, to the BMU.

13. The system of claim 10, wherein the RFID tag comprises a voltage comparator configured to measure the voltage of the cell.

14. The system of claim 13, wherein, when the RFID tag measures the voltage of the cell, the voltage comparator is configured to drain a small amount of energy from the cell to operate and simultaneously lower the voltage of the cell.

15. The system of claim 10, wherein the BMU is configured to continuously transmit a voltage measurement request to one or more cells in the battery until a voltage of all of the one or more cells equals to that of a cell with the lowest voltage.

16. A system configured to balance voltage in a plurality of cells, comprising:
a battery monitoring unit (BMU) configured to monitor and balance voltage in each of the plurality of cells, wherein
each of the plurality of cells comprises a low power radio frequency identification (RFID) tag configured to communicate data with the BMU, wherein
the low power RFID tag comprises
a RF antenna configured to communicate with the BMU, and
a voltage measurement circuit configured to measure voltage of a corresponding one of the plurality of cells.

17. The system of claim 16, wherein the RFID tag is configured to remain in a sleep state until a wakeup signal is received from the BMU.

18. The system of claim 17, wherein the RFID tag is configured to receive a signal from the BMU, wherein energy from the signal is configured to initially power the RFID tag.

19. The system of claim 18, wherein, when the RFID tag is an active state, the RFID tag is configured to consume a small amount of energy from the corresponding one of the plurality of cells.

20. The system of claim 19, wherein the voltage measurement circuit is configured to measure the voltage of the corresponding one of the plurality of cells, wherein the measurement of the voltage is configured to power the RFID tag.

21. The system of claim 20, wherein the RF antenna is configured to communicate the measured voltage of the corresponding one of the plurality of cells.

22. The system of claim 18, wherein the BMU is configured to transmit a signal to each RFID tag, wherein the signal is configured to instruct the RFID tag to measure voltage of the corresponding one of the plurality of cells.

23. The system of claim 22, wherein the BMU, upon receipt of a measured voltage for each of the plurality of cells, is configured to compare the measure voltage to identify a lowest voltage cell among the plurality of cells.

24. The system of claim 23, wherein the BMU is configured to continuously monitor voltages for each of the plurality cells with a higher voltage than the lowest voltage cell until all of the cells in the plurality of cells have a voltage that is equal to one another.
